(19) United States
(12) Patent Application Publication
(10) Pub. No.: US 2005/0087307 A1
(43) Pub. Date: Apr. 28, 2005

(54) Application device for labels that vary in length

(76) Inventor: Johannes Lenkl, Freising (DE)

Correspondence Address: CHRISTIE, PARKER & HALE, LLP, PO BOX 7068, PASADENA, CA, 91109-7068, US

(21) Appl. No.: 10/504,836

(22) PCT Filed: Feb. 5, 2003
(86) PCT No.: PCT/EP03/01134

(30) Foreign Application Priority Data
Feb. 18, 2002 (DE) 102 06 705.8

(51) Int. Cl. B65C 1/02; B65H 29/00

(52) U.S. Cl. 156/556; 156/540; 156/247

(57) ABSTRACT

A method and apparatus for applying individual flat material segment to be separated from a flat material web to products. The products are moved continuously past the application device. The device includes a separation unit for separating the flat material segment from the flat material web. The device also includes an application unit for applying the flat material segment to the product, and a buffer unit between the separation unit and the application unit for the intermediate storage of the flat material segment so as to decouple the feeds at the separation unit and the application unit.

### CROSS-REFERENCE TO RELATED APPLICATION

This application is a National Phase Patent Application of International Application Number PCT/EP03/01134, filed on Feb. 5, 2003, which claims priority of German Patent Application Number 102 06 705.8, filed Feb. 18, 2002.

### FIELD OF THE INVENTION

The invention relates to an application device for applying segments of flat material, in particular labels, and a method of applying such segments of flat material to a product.

### BACKGROUND

Conventional self-adhesive labels are customarily made by firstly producing a flat material web of which one side has an adhesive layer and the other side can be printed upon by means of a printing unit. In order to ensure that the self-adhesive flat material web does not adhere to conveyor rollers, printing rollers, and the like in the printing unit for printing the labels, the self-adhesive flat material web is covered with a carrier material web at the side of the adhesive layer. That self-adhesive flat material web is generally wound up to form a roll whereby handling of the self-adhesive flat material web and its storage are facilitated.

Application devices have previously been used to apply predominantly pre-stamped, self-adhesive labels having predetermined dimensions of length and width. The maximum width of a label is predetermined by the width of the flat material web. Pre-stamped labels of that kind can be applied continuously without stopping the product to be labelled. If, however, labels of a different length are to be applied to products, the application device or labelling machine has to be reconfigured, which requires the application device to be stopped and results in an increase in labelling costs per product.

In conventional “linerless” labels, the self-adhesive flat material web does not have any carrier material web. Such a flat material web can be rolled up like a conventional adhesive strip. This permits an increased level of productivity by virtue of more efficient rolling and, thus, shorter setting times. In addition, linerless labels are particularly environmentally-friendly, as there is no waste of silicone-bearing carrier material. Further advantages are reduced cost in stockkeeping, transport, and waste disposal due to the processing of up to 50% more label material. In addition, linerless labels are not pre-stamped but are continuously drawn off a roll and cut to the required length. In that case, labels of differing lengths can be advantageously produced from the same flat material web.

Just as in the case of the linerless labels, labels are also produced from a flat material web with a carrier material that are not pre-stamped, but cut off the flat material web at a desired length.

If in industrial manufacture, for example, large numbers of products are to be provided with labels of varying lengths at a high throughput rate, the use of a self-adhesive flat material web lends itself to labels, with or without a carrier material web, in a non-pre-stamped form. Accordingly, an application device in that use can produce labels of the desired dimensions in an extremely flexible fashion and apply them to products.

The necessary cutting operation in that case, which separates a flat material segment from a flat material web with or without a carrier material for the production of a label, suffers from a serious disadvantage. For each individual label, the feed of the flat material web must be stopped in order to permit the label to be separated in a trouble-free manner. This procedure involves stopping, or at least decelerating, the products to be labelled at the application device. The consequence of this is a lower product throughput rate. Accordingly, such a stop-and-go mode of operation involves a higher level of material wear and energy consumption.

### OBJECT

The object of the present invention is to provide a device and a method of applying or putting on self-adhesive labels, wherein, in particular, the labels can be continuously applied without stopping the products to be labelled. The invention further seeks to provide a simple structure for the application device and easy and trouble-free handling. In addition, the invention seeks to maximize the flexibility with which different length labels can be applied. One or more of the objects may be met with various embodiments of the invention.

### SUMMARY

One embodiment of an application device according to the invention has a buffer or a buffer unit between a separation unit for separating a flat material segment from the flat material web. The embodiment also includes an application unit for applying such a flat material segment in the form of a label to a product. The buffer or the buffer unit advantageously decouples the operation of applying the labels to the products from the separation operation which takes a finite period of time. The cycle rate of the products to be labelled is thus independent of the duration of the separation operation for a label.

The buffer or the buffer unit of the application device according to various embodiments of the invention may include a variable loop formed from the flat material web between the separation unit and the application unit prior to each separation operation. The length of that loop represents the flat material web portion which can be taken from the buffer unit. The loop is at least as long as the distance that is covered by the surface of a product to be labelled at the application unit during the duration of the separation operation of the flat material segment.

The loop is formed in the buffer unit by controlling the feed speed of the flat material web in such a way that, at least temporarily, between two separation operations, it runs at a higher feed speed than the speed of the products to be labelled, as they move past the application device.

For that purpose, the buffer unit has a controlledly driven feed roller and a pressure roller that is spaced from the feed roller in the feed direction of the flat material web. The feed roller can be arranged in a detachment unit and can advance the flat material segment at a speed that is predetermined at any time. The pressure roller is provided for pressing the flat material segment against the surface of the product at the application unit. Both the feed roller and also the pressure roller are arranged parallel to each other and to the plane defined by the surface of the product. In that way, a dispensed label is discharged by the application device, advantageously aligned with respect to the surface to be labelled. It is also possible to provide a controlled drive at the pressure roller.

For controlling the feed speed, the application device can have a control unit. The control unit controls the speed of the driven feed roller of the buffer unit as described above so that, between two separation operations, the arrangement guarantees the formation of the loop of the required length from the flat material web. To detect the feed speeds of the flat material web at the detachment unit, a sensor can be provided at the detachment unit. The sensor communicates the detected speed to the control unit. Alternatively, a sensor can be provided at the application unit or the conveyor device for detecting the speed of the products at the application unit, which transmits the speed to the control unit.

The flat material web can comprise both a carrier material web, on which a self-adhesive label material web is disposed, and a carrier material-less label web. In the embodiment with a carrier material web, it is removed from the flat material web upstream of the separation unit.

In one embodiment of a method of applying individual flat material segments, the flat material web is fed by a feed unit. Each flat material segment is separated by a separating unit and applied to a product by an application unit. The feed of the flat material web is then decoupled from the feed of the flat material segments by a buffer unit.

### BRIEF DESCRIPTION OF THE DRAWINGS

FIG. 1 is a schematic side view of an application device according to one embodiment of the invention; and

FIG. 2 shows an exploded detail view D of the embodiment shown in FIG. 1.

### DETAILED DESCRIPTION

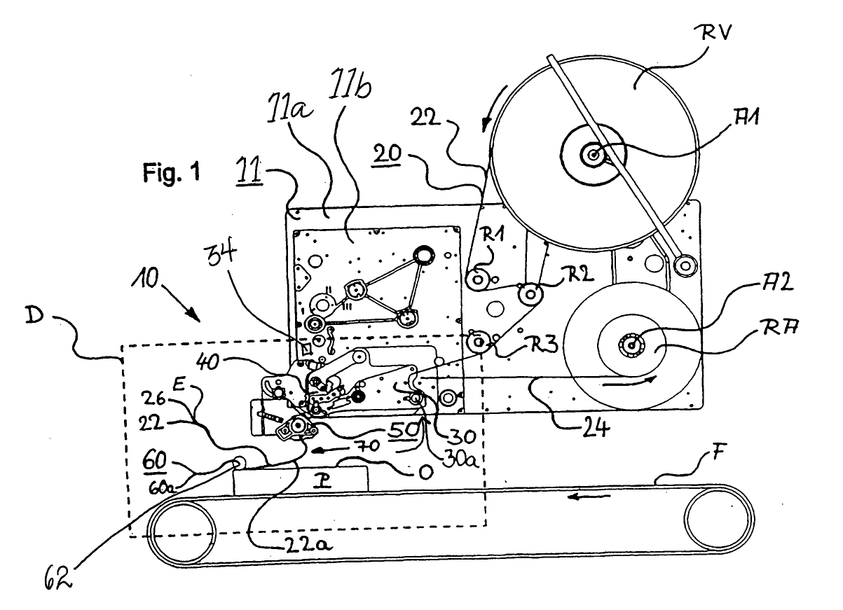

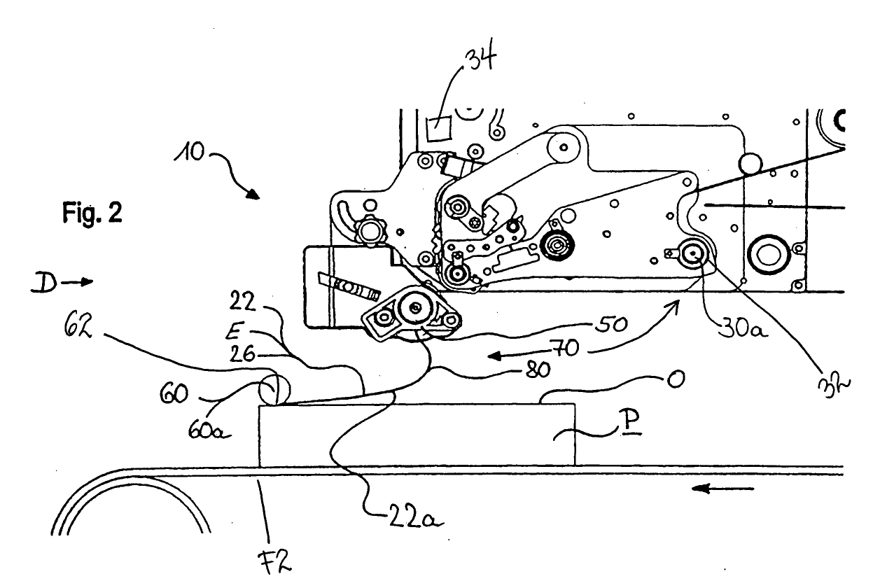

FIGS. 1 and 2 show an application device 10 according to one embodiment of the invention. The device 10 is used to apply labels E or the like to at least a part of the surface O of products P which are moved by a conveyor device F past the application device 10 from right to left in a horizontally extending plane. The housing 11, which surrounds the assemblies of the device 10, is partially removed in FIGS. 1 and 2. Only the substantially vertically extending rear wall 11a and a carrier plate 11b mounted thereon are illustrated.

In the illustrated embodiment of the application device 10, the labels E are made from a flat material web 20, which comprises a self-adhesive label web 22 and a carrier material web 24 that is disposed on the adhesive side 22a of the self-adhesive label web 22. The flat material web 20 is loaded in the form of a supply roll RV into the device 10 by fitting the roll RV on a spindle A1, which is shown at the top right in FIG. 1, and which projects perpendicularly from the rear wall 11a. The flat material web 20 is fed from the supply roll RV by way of horizontally oriented guide rollers R1, R2, R3 to a detachment unit 30. In the detachment unit 30, the label web 22 is detached from the carrier material web 24 by being pulled therefrom at a dispensing edge. The carrier material web 24, without the label web 22, is then guided from the detachment unit 30 to a waste roll RA, which is shown at the right in FIG. 1, and which is fitted on a spindle A2 projecting perpendicularly from the rear wall 11a, and is wound up by the roll RA.

Adjoining the detachment unit 30 in the direction of conveying movement of the flat material web 22 is a printing unit 40. In the printing unit 40, segments of the label web 22 can be printed upon with the desired information. Printing can take place, for example, with a known thermotransfer printing process. A segment of the label web 22, which is printed upon in that way, is then fed to a separation unit 50.

The detachment unit 30 includes a controlledly driven feed roller 30a for the controlled advancement of the label web 22 in the direction of the separation unit 50 or an application unit 60 adjoining the separation unit 50 in the feed direction. The label web 22 that is supplied from the printing unit 40 is engaged by a guide, and then fed without slippage, by the controlled feed roller 30 to the application unit 60. The feed roller 30a is controlled by a control unit. The feed speed can be defined at any time.

The application unit 60 substantially comprises a pressure roller 60a, which is oriented horizontally in relation to the plane defined by the product surface O to be labelled, and which presses the label E against the surface O of the product P. The free-running pressure roller 60a can be resiliently mounted to be reversibly displaceable in the direction of the surface of the product P so that, at any time, a sufficient pressing force can be applied by way of the pressure roller 60a for fold-free application of the label E. The free-running pressure roller 60a can additionally be provided with a sensor element 62 in such a way as to permit the speed of the products P to be labelled to be detected. The sensor may also detect faults and problems with the system, such as an absence of the products P. It will be appreciated that such a sensor system can also be provided independently of the pressure roller 60a.

FIG. 2 shows additional detail of the application device 10 of FIG. 1, including the separation unit 50, which adjoins the printing unit 40; the application unit 60; and one embodiment of a buffer unit 70 arranged therebetween. The buffer unit 70 comprises the controlled feed roller 30a and the pressure roller 60a, between which a loop 80 of the flat material web 22 can be formed as a buffer, the loop 80 being variable from the label E to be applied. The buffer unit 70 makes it possible to decouple the application operation from the separation operation in respect of a label E. This is achieved by the specific and targeted co-operation of the controlled feed roller 30a and the pressure roller 60a of the buffer unit 70. The necessary co-ordination between the feed speed at the feed roller 30a and the conveyor speed of the product or products P is ensured by the control unit 34 in the application device.

The control unit 34 ensures suitable time control of the feed speed of the label web 22 in the separation unit 50 by means of the controlledly driven feed roller 30a in relation to the speed of the product or products P to be labelled on the conveyor device F at the application unit 60. This provides for filling the buffer unit 70, that is to say forming the loop 80, between two separation operations in the separation unit 50. In that respect, in principle the feed speed of the flat material web 20 or the label web 22 between two separation operations can be constantly higher than the speed of the products P on the conveyor device F. This corresponds to a constant speed profile (v_{E}(t)=constant) of the feed speed v_{E} between two separation operations. It is, however, also possible to ‘fill up’ the buffer unit 70 with a loop 80, with a speed profile of a different configuration (v_{E}=v_{E}(t)). For example, immediately after a separation operation, beginning with a strongly accelerated feed movement, the flat material web 20 or the label web 22 can be advanced very quickly and then braked linearly or exponentially. As a feedback means, the current speeds of the product or products P at the application device 10 and the label web 22 at the separation unit 50 can be made available to the control unit by way of sensors 32, 62, F2 which can be provided, for example, at the feed roller 30a, the pressure roller 60a, and the conveyor device F.

If the speed of the products P at the application device 10 is vₚ and if the separation operation for separating a label E, requires the period of time Δt, then the loop length Lₛ₁ which is to be accommodated in the buffer unit 70 approximately corresponds to vₚ·Δt. With the period of time t_{E} for applying a label E the feed speed v_{E} in a first approximation for forming the loop is at least (v_{P}·t_{E})/(t_{E}−Δt). Due to dead time in the feed speed control procedures, the speed in practice is to be selected at a higher value.

The control unit 34 guarantees the formation of the respectively required loop lengths between two separation operations, by way of the drive speed of the feed roller 30a. If a constant feed speed (v_{E}=constant) is not selected, then the length l_{S2} of the loop 80 produced in the buffer unit corresponds to the integral over the speed profile v_{E}=v_{E}(t):

$${l}_{S2} = {\int }_{0}^{{t}_{E} - Δ t} {v}_{E} ( t ) ⅆ t$$

The desired decoupling effect can be satisfied by l_{S1}≦l_{S2}.

When applying a label E, first a printed segment of the label web 22 is fed to the separation unit 50 from the printing unit 40. The segment of the label web 22 is passed by the feed roller 30a in the direction of the surface O to be labelled of the product P. Due to the self-adhesive property of the side 22a of the label web 22, it remains adhering to the product P upon coming into contact with the surface O thereof. To ensure that the label web 22 adheres securely and without folds, it is pressed against the surface O of the product P by the pressure roller 60a, in the application unit 60. From that moment on, the end of the label web 22 moves with the surface O of the product P at the conveyor speed vₚ. The control unit 34 for less than a time t_{E}−Δt causes the feed roller 30a to operate at the feed speed v_{E}=constant or, as discussed above, with a different speed profile v_{E}=v_{E}(t). More label web 22 thereby passes through the separation unit 50 than is applied to the surface O of the product P. The loop 80 of the buffer unit 70 is thereby formed with the required length. The length is preferably in the region downstream of the separation unit as far as the application unit 60. In one embodiment, the control unit 34 can recognize, by means of a timer function, when the necessary loop length is attained. As soon as the required loop length is formed, the label web 22 is stopped for at least the duration of a separation operation Δt. Subsequently, separation of the label E is immediately implemented at the separation unit 50. Tearing or damaging the labels E is therefore avoided.

While the feed roller 30a is stopped, the application operation at the product P is continued by the label web 22 which is stored in the form of a previously formed loop 80. The label web 22 can be stopped for separating a label E without stopping or decelerating the product or products P which is or are to be labelled.

A further possible way of providing a buffer or a loop can be attained if the strip speed of the product P to be labelled is accelerated or slowed down, with the material web being advanced at the same speed at the same time.

If three application devices are combined together in such a way that the respective pressure rollers are respectively oriented horizontally in relation to one of the three sides of the products, which are in orthogonal relationship with the plane defined by the pressure rollers of the application units, then different labels can be applied simultaneously to all three sides in one pass.

In a time-controlled mode of operation between two separation operations, therefore, more label web can be moved past the separation unit than is applied to the product to be labelled. This affords a buffer which can be used up during the individual separation operations.

The invention has been described with reference to various figures and embodiments, but is not limited thereto. It is expected that persons skilled in the art can and will design alternative embodiments that are within the scope of the invention, which is limited only by the appended claims.

1. An application device for applying an individual flat material segment which is to be separated from a flat material web to a product which is moved continuously past the application device, comprising:
a separation unit for separating the flat material segment from the flat material web;
an application unit for applying the flat material segment to the product; and
a buffer unit between the separation unit and the application unit for the intermediate storage of the flat material segment.

2. The application device as in claim 1, wherein the buffer unit is adapted to produce a variable loop formed from the flat material segment between the separation unit and the application unit prior to the separation of the flat material segment from the flat material web.

3. The application device as in claim 2, wherein the length of the loop is at least as long as a distance which a surface of the product travels at the application unit during the separation of the flat material segment from the flat material web.

4. The application device as in claim 1, wherein the buffer unit has a controlledly driven feed roller and a pressure roller, wherein the feed roller is provided in a detachment unit for feeding the flat material segment at a speed which is predetermined at any time, and the pressure roller is provided for pressing the flat material segment against a surface of the product at the application unit.

5. The application device as in claim 4, wherein feed roller and pressure roller axes are arranged parallel to each other and to a plane defined by the surface of the product.

6. The application device as in claim 4, wherein the pressure roller is controlledly driven.

7. The application device as in claim 4, further comprising a control unit for controlling the speed of the feed roller of the buffer unit.

8. The application device as in claim 7, further comprising a sensor in the detachment unit for detecting feed speeds of the flat material web at the detachment unit and communicating the detected feed speed to the control unit.

9. The application device as in claim 7, wherein provided at the application unit or a conveyor device is a sensor for detecting the speed of the product at the application unit and for communicating the detected speed to the control unit.

10. The application device as in claim 1, wherein the flat material web comprises a carrier material web on which is disposed a self-adhesive label material web.

11. The application device as in claim 1, wherein the flat material web is a self-adhesive label material web without a carrier material.

12. A method of applying individual flat material segments that are to be separated from a flat material web, to products that are moved continuously past the application device, comprising:
feeding the flat material web by means of a feed unit,
separating a flat material segment from the flat material web by a separation unit;
applying the flat material segment to the product by an application unit; and
decoupling the feed of the flat material web at the separation unit from the feed of the flat material web segment at the application unit using a buffer unit.

13. The application method as in claim 12, wherein decoupling comprises forming a variable loop of the flat material web between the separation unit and the application unit prior to separating the flat material segment from the flat material web.

14. The application method as in claim 13, wherein the loop is formed by taking at least a length of the flat material web equal to the distance that the product travels at the application unit during separation of the flat material segment from the flat material web.

15. The application method as in one of claims 13 or 14, further comprising:
controlling the formation of the loop in the buffer unit by setting a feed speed of the feed unit between two separation operations such that the feed speed of the flat material web at the separation unit is at least temporarily greater than the speed of the product.

16. The application method as in claim 12, that further comprising detecting the speed of the flat material web at a detachment unit.

17. The application method as in claim 12, further comprising detecting the speed of the product at the application unit or a conveyor device.

18. The application method as in claim 12, wherein upon separation of a flat material segment, a feed of the flat material web at the separation unit is stopped at least for the duration of the separation of the flat material segment from the flat material web.
